(19) United States
(12) Patent Application Publication
(10) Pub. No.: US 2017/0054645 A1
(43) Pub. Date: Feb. 23, 2017

(54) COMMUNICATION DEVICE, NETWORK MANAGEMENT DEVICE, AND NETWORK SYSTEM

(71) Applicant: FUJITSU LIMITED, Kawasaki-shi (JP)

(72) Inventor: Kazuto Nishimura, Yokohama (JP)

(73) Assignee: FUJITSU LIMITED, Kawasaki-shi (JP)

(21) Appl. No.: 15/226,495

(22) Filed: Aug. 2, 2016

(30) Foreign Application Priority Data
Aug. 20, 2015 (JP) 2015-163191

(51) Int. Cl. H04L 12/841; H04L 12/26; H04L 12/819

(52) U.S. Cl. CPC H04L 47/283; H04L 47/215; H04L 43/0882; H04L 47/20

(57) ABSTRACT

There is provided a communication device including: a memory configured to store a procedure for controlling a transmission rate of a packet based on an amount of tokens; a processor configured to execute the procedure by: requesting the amount of tokens to a network management device; and supplying the amount of tokens supplied from the network management device in response to the requesting, to other communication devices belonging to a group to which the communication device also belongs; and a hardware processor configured to transfer request processing and supply processing of the amount of tokens which are executed by the processor, to one of the other communication devices belonging to the group, that satisfies a delay condition related to a delay time of communication and a load condition related to a load of processing in the group.

### CROSS-REFERENCE TO RELATED APPLICATION

This application is based upon and claims the benefit of priority of the prior Japanese Patent Application No. 2015-163191, filed on Aug. 20, 2015, the entire contents of which are incorporated herein by reference.

### FIELD

The embodiments discussed herein are related to a communication device, a network management device, and a network system.

### BACKGROUND

With an increase in demand for communication, a bandwidth of traffic that flows through a network has increased. A communication carrier that operates a network controls a bandwidth of traffic for each contract with a user in order to secure service for the user and limit the flow of traffic.

The bandwidth control of traffic is achieved, for example, by a policer, a shaper, or the like. Each of the policer and the shaper controls a transmission rate of packets based on tokens supplied depending on a contract rate. The policer is provided on the inlet side of traffic in a communication device, and passes or discards packets based on an accumulation amount of tokens, and the shaper is provided on the outlet side of traffic, and controls a transmission amount of packets based on the accumulation amount of the tokens. The contract rate is set for each household in a case of an individual user, and set for each office or the like in a case of a corporate user.

In an example of the bandwidth control, the total rate of pieces of traffic output from a plurality of bases of users, which have been distributed in a network, is limited to a contract rate. In this case, the bandwidth control is performed at a node that is a confluence of the pieces of traffic from the plurality of bases.

However, the bandwidth control is not performed until traffic reaches the node that is the confluence, so that traffic that exceeds the contract rate flows before the node that is the confluence. Therefore, due to traffic discarded by the bandwidth control, the bandwidth of a communication path between the base and the confluence is used wastefully. In addition, there is also a problem that it is difficult to perform the bandwidth control because traffic that has been output from a base in another network does not pass through the node that is the confluence.

For example, when the rates of nodes in a network are managed so as to be centralized by a single management device as discusses in Japanese Laid-open Patent Publication No. 2007-243419, the above-described problem does not occur. In this case, for example, the bandwidth control is performed over the whole network in theory when a bandwidth control function is divided into a centralized token management unit that intensively manages the rates of pieces of traffic by supply of tokens and a distribution policing unit that controls the transmission rate of packets by the tokens that have been supplied from the centralized token management unit as discussed in Japanese Laid-open Patent Publication No. 2013-197823.

### SUMMARY

According to an aspect of the invention, a communication device in a network formed by a plurality of communication devices and a network management device, the communication device of the plurality of communication devices includes: a memory configured to store a procedure for controlling a transmission rate of a packet based on an amount of tokens; a processor configured to execute the procedure by: requesting the amount of tokens to the network management device; and supplying the amount of tokens supplied from the network management device in response to the requesting, to other communication devices belonging to a group to which the communication device also belongs; and a hardware processor configured to transfer request processing and supply processing of the amount of tokens which are executed by the processor, to one of the other communication devices belonging to the group, that satisfies a delay condition related to a delay time of communication and a load condition related to a load of processing in the group.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a bandwidth control method in a comparative example;

FIG. 2 is a diagram illustrating a bandwidth control method in another comparative example;

FIG. 3 is a configuration diagram illustrating a network system according to an embodiment;

FIG. 4 is a diagram illustrating a sharing example of intermediate nodes among users;

FIG. 5 is a configuration diagram illustrating an example of a node according to the embodiment;

FIG. 6 is a diagram illustrating an example of a group management table;

FIG. 7 is a sequence diagram illustrating an example of communication in the network system;

FIG. 8 is a diagram illustrating an operation example of group change of a node;

FIG. 9 is a diagram illustrating the network system after the group change;

FIG. 10 is a sequence diagram illustrating an example of the group change;

FIG. 11 is a flowchart illustrating an operation example of a network management device;

FIG. 12 is a flowchart illustrating an operation example of request and supply of tokens in the intermediate node;

FIG. 13 is a flowchart illustrating an operation example of transmission of a user packet in an end node;

FIG. 14 is a flowchart illustrating an example of a handover operation of request processing and supply processing of tokens in the intermediate node;

FIG. 15 is a flowchart illustrating an operation example when a handover instruction has been received at the end node;

FIG. 16 is a flowchart illustrating an operation example when a group change instruction has been received at the end node; and

FIG. 17 is a flowchart illustrating an operation example in the intermediate node when an end node in another group has joined the group.

### DESCRIPTION OF EMBODIMENTS

When the bandwidth control is performed over the whole network as described above, requests of tokens from all nodes in the network are centralized to a single management device, so that the load of processing in the management device increases. In addition, a delay time also exists in communication between the management device and each of the nodes.

Therefore, when supply of tokens from the management device does not make it to packet processing in each of the nodes, discard of a packet occurs, and as a result, the rate of traffic may become less than a contract rate. When frequency of supply of tokens is reduced by increasing an amount of tokens supplied once, an influence of the load of the processing and the delay time may be reduced, but bursts of traffic increase, so that accuracy of the bandwidth control is reduced.

An embodiment of a technology by which a delay time of the bandwidth control of traffic that flows through the network is reduced is described below with reference to drawings.

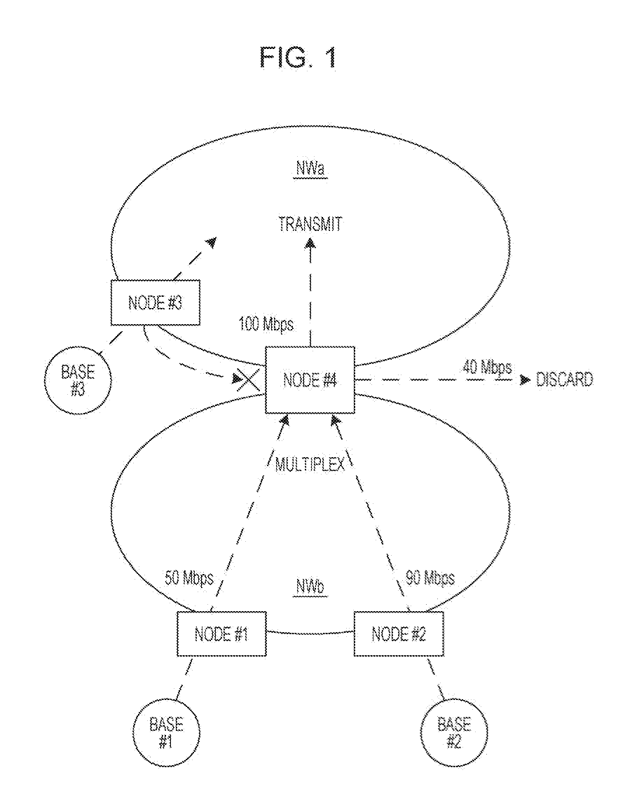

FIG. 1 is a diagram illustrating a bandwidth control method in a comparative example. In such an example, nodes #1, #2, and #4 are coupled to a network NWb on the lower side, and nodes #3 and #4 are coupled to a network NWa on the upper side. The node #4 is coupled to both of the network NWa on the upper side and the network NWb on the lower side.

As an example, in each of the nodes #1 to #4, a communication device such as a router that controls a communication path of traffic is provided. To the communication devices of the nodes #1 to #3, respective pieces of traffic are input from bases #1 to #3 of users. As the bases #1 to #3, for example, there are offices of the users.

The pieces of traffic of the nodes #1 and #2 flow through the network NWb on the lower side and are multiplexed at the node #4. In such an example, it is assumed that the bandwidths of the pieces of traffic of the nodes #1 and #2 are 50 Mbps and 90 Mbps, respectively. In addition, the traffic of the node #3 flows through the network NWa on the upper side without passing through the node #4 (see x mark in FIG. 1).

In the bandwidth control of the example, the total rate the pieces of traffic that have been output from the bases #1 and #2 in the network NWb on the lower side is limited to 100 Mbps that is a contract rate. The bandwidth control is performed at the node #4 that is a confluence of the pieces traffic from the bases #1 and #2. The bandwidth control is performed by controlling the transmission rate of packets based on tokens supplied in accordance with the contract rate. In the node #4, traffic having a portion of 40 (=50+90−100) Mbps is discarded by the bandwidth control.

However, the bandwidth control is not performed until the pieces of traffic arrive at the node #4 that is the confluence, so that the traffic that exceeds the contract rate flows before the node #4 that is the confluence. Therefore, due to the traffic of the portion discarded by the bandwidth control (40 Mbps in this example), the bandwidth of a communication path between the confluence and each of the bases #1 and #2 is used wastefully. In addition, it is difficult to perform the bandwidth control of the traffic that has been output from the base in the network NWa on the upper side because the traffic does not pass through the node #4 that is the confluence.

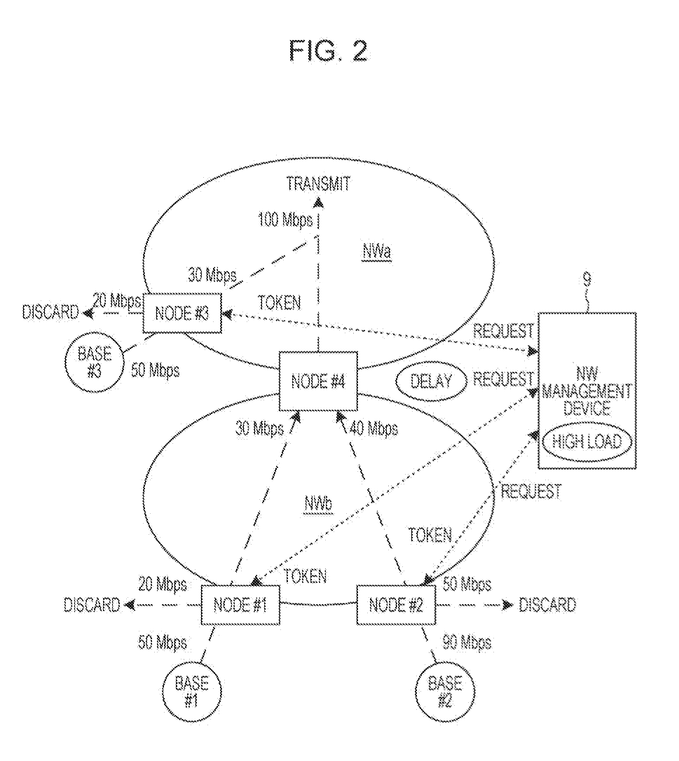

FIG. 2 is a diagram illustrating a bandwidth control method in another comparative example. In FIG. 2, the same symbol or name is assigned to a configuration similar to that of FIG. 1, and the description is omitted herein. In this example, it is assumed that pieces of traffic of the bases #1 to #3 are 50 Mbps, 90 Mbps, and 50 Mbps, respectively.

In this example, a single network (NW) management device 9 centralizes and manages the rates of the respective pieces of traffic that pass through the communication devices of the nodes #1 to #3. The network management device 9 performs monitoring control of the communication device of each of the nodes #1 to #4. The network management device 9 supplies tokens to each of the nodes #1 to #3 in response to a request from the communication device of the node.

Therefore, for example, in the node #1, the bandwidth (50 Mbps) of the traffic of the base #1 may be controlled at 30 Mbps by discarding merely traffic having a portion of 20 Mbps, and in the node #2, the bandwidth (90 Mbps) of the traffic of the base #2 may be controlled at 40 Mbps by discarding merely traffic having a portion of 50 Mbps. Thus, the bandwidth of traffic input to the node #4 that is the confluence is limited to 70 (=30+40) Mbps.

In addition, even in the node #3, the bandwidth (50 Mbps) of the traffic of the base #3 may be controlled at 30 Mbps by discarding merely traffic having a portion of 20 Mbps. Thus, the bandwidths of the pieces of traffic of the node #3 and the node #4 that flow through the network NWa on the upper side is limited to 100 (=30+70) Mbps.

As described above, when a bandwidth control function is divided into the network management device 9 that manages tokens and the nodes #1 to #3 each of which controls the transmission rate of packets based on tokens, in theory, the bandwidth control over the networks NWa and NWb may be performed.

However, when the bandwidth control over the networks NWa and NWb is performed, requests of tokens are centralized from all of the nodes in the networks NWa and NWb to the single network management device 9, so that the load of the processing in the network management device 9 increases (see “high load” in FIG. 2). In addition, there also exists a delay time in communication between the network management device 9 and each of the nodes #1 to #3 (see “delay” in FIG. 2).

Therefore, supply of tokens from the network management device 9 does not make it to packet processing in each of the nodes #1 to #3, and discard of a packet occurs, and as a result, the rate of the traffic may become less than the contract rate.

Thus, in the network system according to the embodiment, nodes are grouped, tokens are requested for the network management device from a single node that has been selected in each of the groups (hereinafter referred to as “intermediate node”), and tokens are supplied to the other nodes in the group (hereinafter referred to as “end nodes”) through the intermediate node. That is, the load of the network management device is suppressed when grouping is performed so that a single intermediate node and the other end nodes are configured so as to be layered in each group.

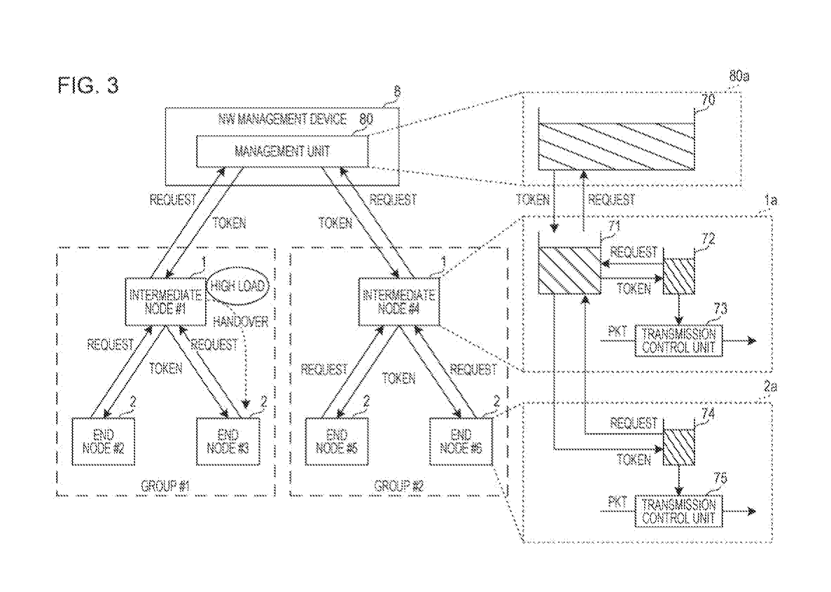

FIG. 3 is a configuration diagram illustrating a network system according to an embodiment. The network system includes a network management device 8, and a plurality of groups #1 and #2 each of which includes an intermediate node 1 and end nodes 2.

An intermediate node #1 1, an end node #2 2, and an end node #3 2 belongs to the group #1, and an intermediate node #4 1, an end node #5 2, and an end node #6 2 belong to the group #2. In the following description, the intermediate node 1 and the end node 2 correspond to communication devices that are provided in the respective nodes, and there is no difference between the configurations.

The network system in this example is obtained by layering the nodes, and in each of the groups #1 and #2, the end node 2 requests tokens for the intermediate node 1, and the intermediate node 1 requests tokens for the network management device 8. The intermediate node 1 is selected for each of the groups #1 and #2, and supplies the tokens that have been supplied from the network management device 8, to the end node 2 in the group in response to the request. Therefore, the number of requests of tokens for the network management device 8 is reduced as compared with the comparative example, and an increase in the load of the processing is suppressed.

The network management device 8 includes a management unit 80 that manages the nodes #1 to #6 1 and 2. The management unit 80 may be, for example, configured with a digital signal processor (DSP) that is a kind of a hardware processor or a central processing unit (CPU) driven by software. The management unit 80 supplies the tokens to the intermediate node 1 in response to a request from the intermediate node 1. A symbol 80a indicates a schematic configuration of the management unit 80. The management unit 80 includes a main bucket 70 that accumulates tokens. Tokens are supplied to the main bucket 70 regularly based on the contract rate of the user. The management unit 80 supplies tokens that have been accumulated in the main bucket 70, in response to a request from the intermediate node 1. A supply amount of tokens once is, for example, 1 Mbyte.

In addition, symbols 1a and 2a respectively indicate schematic configurations of the intermediate node 1 and the end node 2. The intermediate node 1 includes an intermediate bucket 71, a mini-bucket 72, and a transmission control unit 73, and the end node 2 includes a mini-bucket 74 and a transmission control unit 75.

In the intermediate bucket 71, tokens that have been supplied from the main bucket 70 in response to a request are accumulated. Tokens are supplied to each of the mini-buckets 72 and 74 from the intermediate bucket 71 in response to a request, and accumulated in the mini-bucket. An amount of tokens supplied to the mini-bucket 72 once is, for example, 25 Kbyte, which is smaller than the main bucket 70.

The transmission control units 73 and 75 are, for example, policers or shapers, and respectively consume tokens of the mini-buckets 72 and 74 and perform transmission of a packet (PKT). Here, a consumption amount of tokens corresponds to, for example, a packet length portion. Therefore, each of the intermediate node 1 and the end node 2 controls the transmission rate of packets based on the supplied amount of the tokens. As the type of a packet, for example, there is an internet protocol (IP) packet, but the embodiment is not limited to the example.

In addition, as described above, the amount of tokens supplied once (25 Kbyte) in the intermediate bucket 71 is smaller than the amount of tokens supplied once (1 Mbyte) in the main bucket 70. Therefore, in the end node 2, occurrence of an excessive amount of bursts of traffic is avoided.

Conversely, the amount of tokens supplied once in the main bucket 70 is larger than the amount of tokens supplied once in the intermediate bucket 71. Therefore, request frequency of tokens for the network management device 8 from the intermediate node 1 becomes smaller than request frequency of tokens for the intermediate node 1 from the end node 2.

However, the intermediate node 1 executes request processing of requesting tokens for the network management device 8 and supply processing of supplying tokens to the end node 2 in response to the request of tokens, in addition to the processing executed by the end node 2. Therefore, when the load of the request processing and the supply processing of tokens in the intermediate node 1 increases, the increase in the load of the processing may cause a bottleneck of token supply.

Therefore, the intermediate node 1 hands over the request processing and the supply processing of tokens to an end node 2 that satisfies a delay condition related to a delay time of communication in each of the groups #1 and #2 and a load condition related to the load of the processing from among the end nodes 2 that belong to the group. As an example of the delay condition, there is a condition that delay times of communication for all of the other end nodes 2 in the same group as an end node 2 that is a candidate of a new intermediate node 1 are smaller than a certain threshold value thD. In addition, as an example of the load condition, there is a condition that the load of the processing in the end node 2 that is the candidate of the new intermediate node 1 is smaller than a certain value thC.

In the example of FIG. 3, the load of the intermediate node #1 1 of the group #1 increases (see “high load” in FIG. 3), so that the request processing and the supply processing of tokens is handed over to the end node #3 2 in the group #1, which satisfies the delay condition and the load condition (see “handover” in FIG. 3). As a result, from among the end nodes 2 in each of the groups #1 and #2, an end node 2 in which the delay time is low and the load is low is selected as a new intermediate node 1, so that the request processing and the supply processing of tokens are continued appropriately after the handover.

In the handover, information on a token accumulation amount or the like of the intermediate bucket 71 of the intermediate node 1 is handed over (transferred) to the end node #3 2. After that, the end node #3 2 starts the request processing and the supply processing of tokens as a new intermediate node 1 of the group #1.

As described above, the intermediate node 1 in each of the groups #1 and #2 is not fixed to a certain node and may be dynamically replaced with another node depending on the load of the processing. Therefore, supply of tokens to the end node 2 is performed so as to make it to the processing of a packet. Thus, a delay time of the bandwidth control of traffic that flows through the network is reduced. The replacement of the intermediate node 1 may be performed when the load of the processing of the intermediate node 1 exceeds a certain value thB, or when a response time of the intermediate node 1 in response to a request of tokens from the end node 2 is a certain time T or more.

The intermediate node 1 at the time of operation start of the network system, that is, the initial intermediate node 1 is selected in accordance with various criteria. For example, the initial intermediate node 1 may be a node having the lowest load of the processing in each of the groups #1 and #2. The replacement of the intermediate node 1 is performed when the load of the processing increases, so that the number of times of replacement of the intermediate node 1 may be reduced when a node having the lowest load is selected as the initial intermediate node 1.

In addition, the initial intermediate node 1 may be a node having the smallest maximum delay time of communication in each of the groups #1 and #2. As described above, supply frequency of tokens from the intermediate node 1 to the end node 2 is higher than supply frequency of tokens from the network management device 8 to the intermediate node 1. Therefore, when a node having the smallest maximum delay time of communication in each of the groups #1 and #2 is selected as the initial intermediate node 1, a used time of token supply to the end node 2 may be reduced.

In addition, the initial intermediate node 1 may be a node that is the closest to the network management device 8 in each of the groups #1 and #2. In this case, a delay time of communication between the intermediate node 1 and the network management device 8 may be minimized. At that time, when the network management device 8 is located at the position near the center of the nodes in the network, a delay time of communication between the intermediate node 1 and the end node 2 may also be reduced.

As the intermediate node 1, merely a single node may be selected for pieces of traffic of the users, but transmission rate control in each of the transmission control units 73 and 75 is performed for each piece of traffic, so that an individual node may be selected for each of the pieces of traffic of the users as described in the following example.

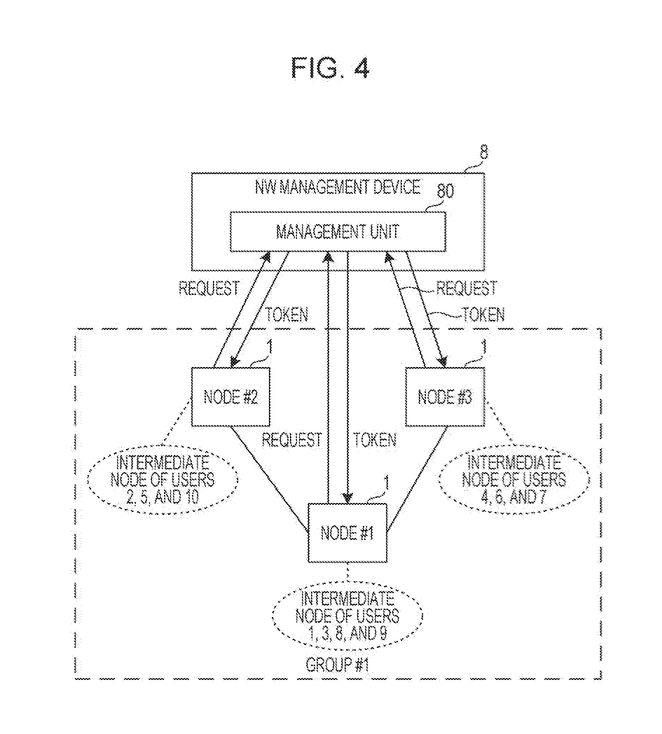

FIG. 4 is a diagram illustrating a sharing example of intermediate nodes for users. In FIG. 4, the same symbol or name is assigned to a configuration similar to that of FIG. 3, and the description is omitted herein. Nodes #1 to #3 belong to a group #1, and an intermediate node 1 for traffic of each of user 1 to 10 is individually selected from the nodes #1 to #3.

The node #1 is selected as the intermediate node 1 of pieces of traffic of the users 1, 3, 8, and 9, and the node #2 is selected as the intermediate node 1 of pieces of traffic of the users 2, 5, and 10. In addition, the node #3 is selected as the intermediate node 1 of pieces of traffic of the users 4, 6, and 7.

Each of the nodes #1 to #3 requests tokens for the network management device 8 for each of the pieces of traffic of the corresponding users. When each of the nodes #1 to #3 requests tokens for all of the pieces of traffic of the users, the number of requests becomes “the number of users×the number of nodes (=10×3=30)”, but in this example, the number of requests is reduced to the total number of users (=10) among which the intermediate nodes 1 are shared. This case is also applied to a case in which a single intermediate node 1 requests tokens for all of the pieces of traffic of the users.

However, as described in this example, when the intermediate node 1 is selected for each of the pieces of traffic of the users, the request processing and the supply processing of tokens in the intermediate node 1 are distributed to a plurality of nodes. On the other hand, when a single intermediate node 1 that is shared between the pieces of traffic of all of the users is selected, there is an advantage that tokens in the group #1 may be managed together by the intermediate node 1. A configuration of each of the nodes 1 and 2 is described below.

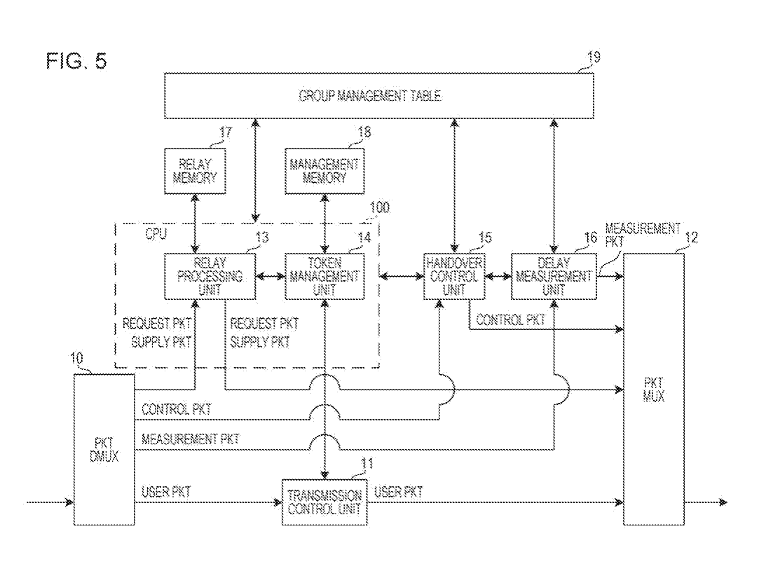

FIG. 5 is a configuration diagram illustrating an example of each of the nodes 1 and 2 according to the embodiment. Each of the nodes 1 and 2 includes a packet (PKT) demultiplexer (DMUX) 10, a transmission control unit 11, a packet (PKT) multiplexer (MUX) 12, a relay processing unit 13, a token management unit 14, a handover control unit 15, a delay measurement unit 16, a relay memory 17, a management memory 18, and a group management table 19. The relay processing unit 13 and the token management unit 14 may be configured, for example, as a function of a central processing unit (CPU) 100 driven by software. The CPU 100 may include a processor and a memory to store a procedure for the software.

The PKT DMUX 10 identifies the type of a packet based on an identifier in the packet and outputs the packet to an output destination corresponding to the type of the packet. More specifically, the PKT DMUX 10 outputs a user packet to the transmission control unit 11, and outputs a request packet indicating a request amount of tokens and a supply packet indicating a supply amount of tokens, to the relay processing unit 13.

In addition, the PKT DMUX 10 outputs a control packet used to control handover of the request processing and the supply processing of tokens in the intermediate node 1, to the handover control unit 15. In addition, the PKT DMUX 10 outputs a measurement packet used to measure a delay time of communication in the group or a delay time of communication with a node in another group, to the delay measurement unit 16.

The PKT MUX 12 multiplexes a user packet, a request packet, a supply packet, a control packet, and a measurement packet that have been input from the respective input sources, and outputs the multiplexed packet to another node through an output port (not illustrated). In a case of the intermediate node 1, the relay memory 17 corresponds to the intermediate bucket 71 of FIG. 3 and records an accumulation amount of tokens that have been supplied from the network management device 8, and in a case of the end node 2, the relay memory 17 is not used. The management memory 18 corresponds to each of the mini-buckets 72 and 74 of FIG. 3 and records an accumulation amount of tokens that have been supplied from the intermediate bucket 71.

In addition, in the case of the intermediate node 1, the relay processing unit 13 transmits a supply packet to an end node 2 when “token accumulation amount≧request amount” is satisfied at the time of reception of a request packet from the end node 2. In addition, when “token accumulation amount<request amount” is satisfied, the relay processing unit 13 transmits a request packet to the network management device 8, and adds a supply amount indicated by a supply packet that has been received from the network management device 8 to the token accumulation amount that has been recorded in the relay memory 17.

As described above, the relay processing unit 13 requests tokens for the management unit 80 of the network management device 8, and supplies tokens that have been supplied in response to the request, to the end node 2 in the same group, in response to a request from the end node 2. In the case of the end node 2, the relay processing unit 13 relays input/output of a request packet and a supply packet between the token management unit 14 and the PKT DMUX 10 or the PKT MUX 12.

In addition, in the case of the end node 2, the token management unit 14 transmits a request packet to the intermediate node 1 in the same group when the token accumulation amount in the management memory 18 becomes smaller than a certain threshold value. When the token management unit 14 receives a supply packet from the intermediate node 1 in response to the request packet, the token management unit 14 adds a supply amount indicated by the supply packet to the token accumulation amount that has been recorded in the management memory 18.

As described above, when the token accumulation amount becomes smaller than the certain threshold value, the token management unit 14 requests tokens for the intermediate node 1. In the case of the intermediate node 1, when the token accumulation amount of the management memory 18 becomes the certain threshold value, the token management unit 14 requests tokens for the relay processing unit 13, and adds an amount of tokens that have been supplied in response to the request to the token accumulation amount that has been recorded in the management memory 18.

The token management unit 14 obtains a destination to which the intermediate node 1 for which tokens have been requested transmits the tokens, from the group management table 19. The group management table 19 is constituted, for example, by a memory, and a configuration for each group and a transmission destination for each node are recorded in the group management table 19.

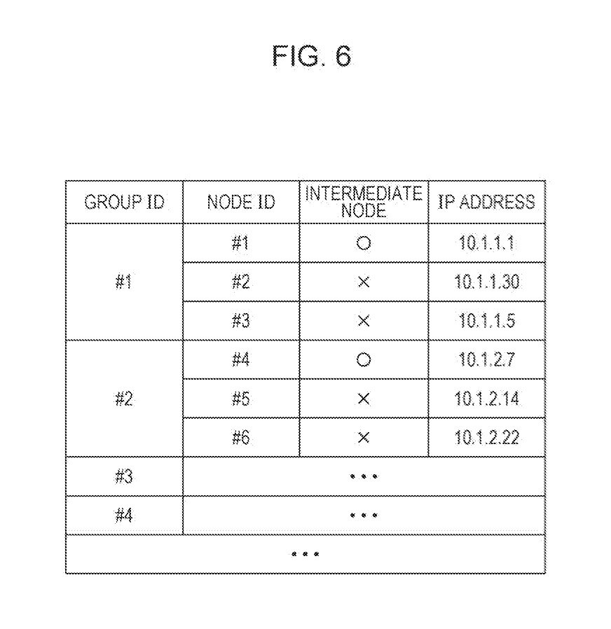

FIG. 6 is a diagram illustrating an example of the group management table 19. In the group management table 19, “group ID” #1, #2, . . . that is an identifier of a group, “node ID” #1, #2, . . . that is an identifier of a node, information on “intermediate node”, and “IP address” are registered.

Here, the information on “intermediate node” indicates whether a node corresponding to a node ID is an intermediate node 1 (“O”: intermediate node 1, and “x”: end node 2). In addition, “IP address” indicates an IP address of the node corresponding to the node ID. Instead of the IP address, a media access control (MAC) address may be registered in the group management table 19.

The group management table 19 is referred to when a transmission destination of a request packet, a control packet, or a measurement packet is detected. In addition, when a configuration of a group is changed, a content of the group management table 19 is updated by the handover control unit 15 as described later.

Referring to FIG. 5 again, the transmission control unit 11 corresponds to each of the transmission control units 73 and 75 of FIG. 3, and controls the transmission rate of packets based on the token accumulation amount that has been recorded in the management memory 18, that is, the token accumulation amount that has been supplied to the corresponding mini-bucket 72 or 74. When “token accumulation amount of the corresponding mini-bucket 72 or 74>0” is satisfied, the transmission control unit 11 consumes the tokens of the corresponding mini-bucket 72 or 74 by a portion of the length of a user packet and performs transmission of the packet. When transmission of the packet has been performed, the token management unit 14 subtracts the portion of the length of the user packet from the token accumulation amount that has been recorded in the management memory 18. In addition, when “token accumulation amount≦0” is satisfied, the transmission control unit 11 discards the user packet or stores the user packet in a buffer without transmission of the user packet.

In addition, in the case of the end node 2, the token management unit 14 measures a response time for a request of tokens for the intermediate node 1. More specifically, the token management unit 14 causes a timer to measure a response time taken from transmission of a request packet to reception of a supply packet. When the measured response time is a certain time T or more, the token management unit 14 notifies the intermediate node 1 of the information indicating that the measured response tie is the certain time T or more, as a control packet, through the handover control unit 15. Such notification is referred to as “supply delay notification” in the following description.

The handover control unit 15, when operating as the intermediate node 1, hands over the request processing and the supply processing of tokens, which are executed by the relay processing unit 13, to a communication device of a node that satisfies the above-described delay condition and load condition from among communication devices of the other nodes that belong to the same group. When the handover has been completed, the handover control unit 15 switches the operations of the relay processing unit 13 and the token management unit 14 from the operation of the intermediate node 1 to the operation of the end node 2, and updates the information on “intermediate node” of the group management table 19.

The handover control unit 15 monitors the load of the processing of the own device, and performs the handover of the request processing and the supply processing of tokens when the load exceeds the certain value thB. More specifically, the handover control unit 15 monitors, for example, a usage rate of the CPU 100. The usage rate of the CPU 100 dynamically changes depending on the flow rate of user packets in the node, request frequency of the tokens from the end node 2, and other pieces of processing of an operating system (OS) and the like. Therefore, the handover control unit 15 may monitor the load of the processing of the device based on the usage rate of the CPU 100.

As described above, the handover control unit 15 may detect timing of the handover easily by monitoring the load of the processing of the device. The handover control unit 15 may be, for example, configured with a digital signal processor (DSP) that is a kind of a hardware processor or a central processing unit (CPU) driven by software.

In addition, in the case of the intermediate node 1, supply delay notification is transmitted to the handover control unit 15 from the end node 2. As described above, the supply delay notification is transmitted to the intermediate node 1 from the end node 2 as a control packet. The handover control unit 15 performs the handover of the request processing and the supply processing of tokens when the handover control unit 15 receives the supply delay notification. When the transmission of the supply delay notification is performed, that is, when a response time is the certain time T or more, there is a possibility that the load of the processing of the intermediate node 1 increases. Therefore, the handover control unit 15 may detect timing of the handover easily based on a monitoring result by the end node 2 in the same group.

The detection of timing of the handover may be performed based on at least one of the monitoring results of the load of the processing and the response time. When the response time is merely monitored, the load of the intermediate node 1 is monitored from the end node 2, so that monitoring processing of the load in the intermediate node 1 may be omitted. In the following example, it is assumed that the handover control unit 15 detects timing of the handover based on the monitoring result of the load of the device.

The handover control unit 15 of the intermediate node 1 transmits a handover instruction to the end node 2 in the same group as a control packet, for example, when the load exceeds the certain value thB. At that time, the handover control unit 15 obtains a transmission destination of the handover instruction from the group management table 19.

In addition, in a case in which the handover control unit 15 of the end node 2 receives the handover instruction, when the load of the processing of the device is smaller than the certain value thC, the handover control unit 15 instructs the delay measurement unit 16 to measure a delay time of communication in the group. That is, an end node 2 that satisfies the above-described load condition from among the end nodes 2 measures a delay time of communication in the group.

When the delay measurement unit 16 receives the measurement instruction, the delay measurement unit 16 transmits a measurement packet to other nodes in the same group (the intermediate node 1 and the end node 2). At that time, the delay measurement unit 16 obtains transmission destinations of the measurement packet from the group management table 19. In the node that has received the measurement packet, the delay measurement unit 16 sends back the measurement packet to the end node 2 that is the transmission source.

The delay measurement unit 16 of the end node 2 that is the transmission source measures a round-trip time of the measurement packet, and measures a delay time based on the measured value. The measured delay time is notified to the handover control unit 15. When delay times with all of the nodes in the group are smaller than the threshold value thD, the handover control unit 15 transmits a response for a handover instruction to the intermediate node 1 as a control packet. That is, the handover control unit 15 responds, to the intermediate node 1, information indicating that the end node 2 that satisfies the above-described load condition and delay condition from among the end nodes 2 may become a candidate of the intermediate node 1, in response to the handover instruction.

When the handover control unit 15 of the intermediate node 1 receives the response for the handover instruction from the end node 2, the handover control unit 15 transmits handover information including the token accumulation amount that has been recorded in the relay memory 17 to the end node 2 that is the response source as a control packet. At that time, when there exist a plurality of end nodes 2 that are response sources, the handover control unit 15 selects a single end node 2, and transmits the handover information to the selected end node 2.

After that, the handover control unit 15 transmits handover completion notification to each of the end nodes 2 in the same group. In addition, the handover control unit 15 of the end node 2 that has received the handover information deploys the handover information to the relay memory 17 and the like, and starts the operation as the intermediate node 1. A communication sequence of the network system including the communication devices each having the above-described configuration is described below.

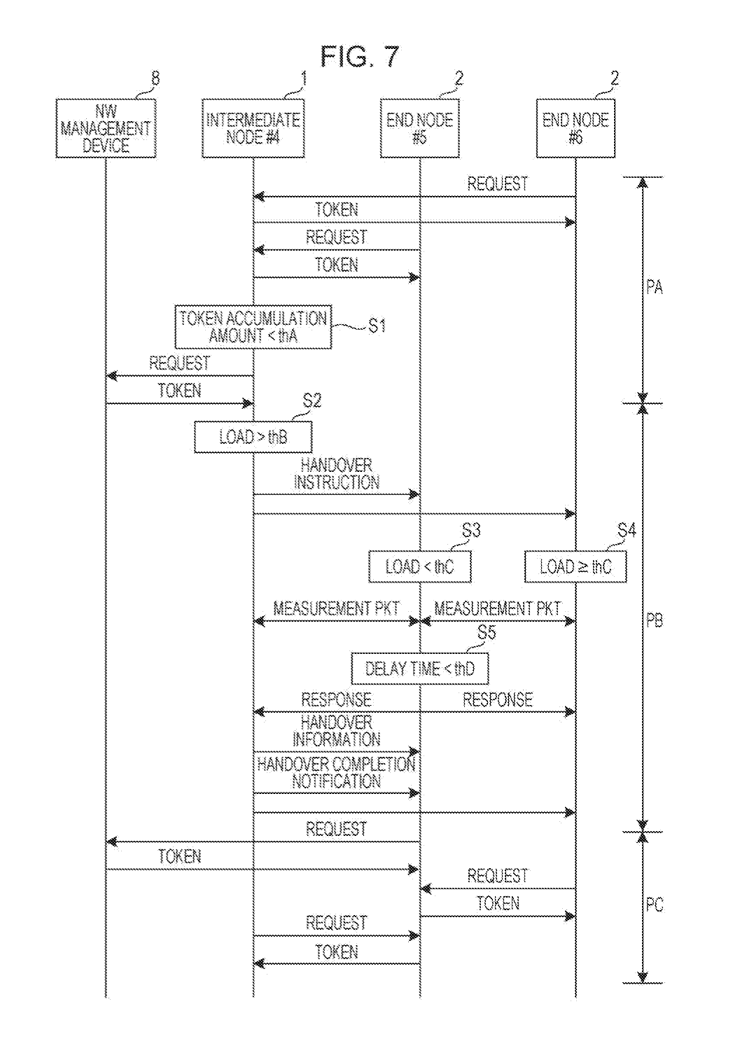

FIG. 7 is a sequence diagram illustrating an example of communication in the network system. In this example, the configuration of the group #2 illustrated in FIG. 3 is described. In FIG. 7, a symbol PA indicates a time period before replacement of the intermediate node 1, a symbol PB indicates a time period of the replacement of the intermediate node 1, and a symbol PC indicates a time period after the replacement of the intermediate node 1.

In the time period PA before the replacement of the intermediate node 1, nodes #5 and #6 that are the end nodes 2 each requests tokens for a node #4 that is the intermediate node 1 and receives supply of tokens. When a token accumulation amount indicated by the relay memory 17 falls below a certain value thA (see symbol S1 in FIG. 7), the intermediate node 1 requests tokens for the network management device 8 and receives supply of tokens.

In the time period PB of the replacement of the intermediate node 1, when the intermediate node 1 detects that the load of the processing of the device exceeds a certain value thB (for example, 70%) (see symbol S2 in FIG. 7), the intermediate node 1 transmits a handover instruction to the end nodes #5 and #6 2. In the end node #6 2, the load of the processing is a certain value thC (for example, 50%) or more (see symbol S4 in FIG. 7), so that the end nodes #6 2 dos not satisfy the load condition. Therefore, the end node #6 2 does not perform delay measurement and does not respond for the handover instruction.

In addition, in the end node #5 2, the load of the processing is smaller than the certain value thC (see symbol S3 in FIG. 7), so that the end node #5 2 satisfies the load condition. Therefore, the end node #5 2 transmits a measurement packet to the intermediate node #4 1 and the end node #6 2, and measures delay times of communication with the intermediate node #4 1 and the end node #6 2.

As a result of the delay measurement, the end node #5 2 determines that both of the delay times with the intermediate node #4 1 and the end node #6 2 are smaller than a threshold value thD (see symbol S5 in FIG. 7), so that the end node #5 2 transmits a response for the handover instruction to the intermediate node #4 1 and the end node #6 2. That is, the end node #5 2 satisfies the above-described delay condition in addition to the above-described load condition, so that the end node #5 2 responds for the handover instruction as a candidate of the intermediate node 1.

When the intermediate node 1 receives the response from the end node #5 2, the intermediate node 1 transmits handover information to the end node #5 2, and transmits handover completion notification to the end nodes #5 and #6 2. After that, the node #4 starts the operation as the end node 2, and the node #5 starts the operation as the intermediate node 1.

However, the node #4 may receive a request of tokens even after the handover has been completed, so that the node #4 operates as the intermediate node 1 with the node #5 merely by a certain time period. When the node #4 receives a request of tokens after the handover has been completed, the node #4 supplies tokens based on the token accumulation amount immediately before the completion of the handover, and notifies the node #5 that is the new intermediate node 1 of the supply amount. The node #5 subtracts the notified supply amount from the token accumulation amount indicated by the relay memory 17. Therefore, accuracy of the token accumulation amount is achieved.

In the time period PC after the replacement of the intermediate node 1, the nodes #4 and #6 that are the end nodes 2 each requests tokens for the node #5 that is the intermediate node 1 and receives supply of tokens. The intermediate node 1 requests tokens for the network management device 8 and receives supply of tokens. The communication in the group #2 is performed as described above.

In addition, there is a case in which an end node 2 that satisfies both of the delay condition and the load condition does not exist when a handover instruction has been transmitted from the intermediate node 1. For example, when the network includes nodes in a wide range, an end node 2 that satisfies the load condition but does not satisfy the delay condition is conceived. In this case, as described in the following example, the end node 2 that satisfies the load condition may remove an end node 2 that interferes with the satisfaction of the delay condition, from the group.

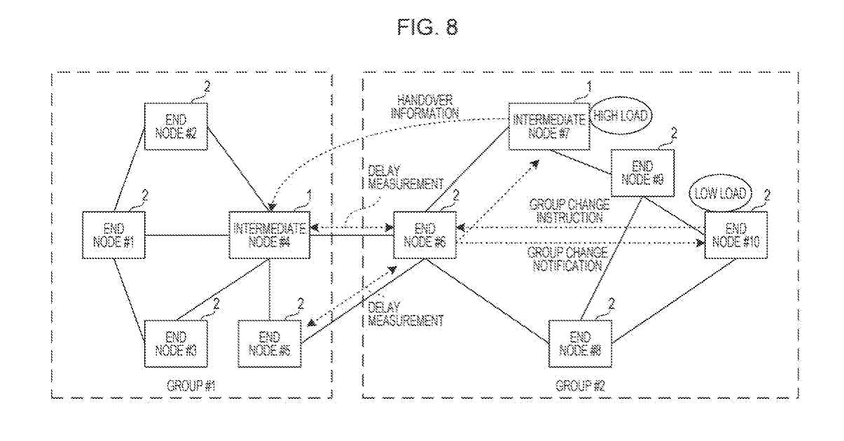

FIG. 8 is a diagram illustrating an operation example of group change of a node. In such an example, nodes #1 to #5 belong to a group #1, and the node #4 is an intermediate node 1. In addition, nodes #6 to #10 belong to a group #2, and the node #7 is an intermediate node 1. An operation in which the group of the node #6 of the group #2 is changed to the group #1 is described below as an example of the group change.

When the load of the processing in the intermediate node #7 1 in the group #2 exceeds a certain value thB (see “high load” in FIG. 8), the intermediate node #7 1 transmits a handover instruction to the end nodes #6 and #8 to #10 2 in the group #2 from the intermediate node #7 1. The end node #10 2 that satisfies the load condition (see “low load” in FIG. 8) transmits a measurement packet to the other nodes #6 to #9. As a result of the delay measurement, when merely a delay time of communication with end node #6 2 is a threshold value thD or more, the end node #10 2 transmits a group change instruction to the end node #6 2.

When the end node #6 2 receives the group change instruction, the end node #6 2 measures a delay time of communication with each of the nodes #1 to #5 in the group #1 that is adjacent to the group #2. In FIG. 8, merely delay times for the intermediate node #4 1 and the end node #5 2 are illustrated (see “delay measurement” in FIG. 8).

As a result of the delay measurement, when delay times of communication with all of the nodes #1 to #5 in the group #1 are less than the threshold value thD, the end node #6 2 notifies the end node #10 2 and the intermediate node #7 1 of information indicating that group change to the group #1 may be performed through group change notification. The intermediate node #7 1 transmits handover information related to the end node #6 2 to the intermediate node #4 1 that is a group change destination in accordance with the group change notification. As a result, the end node #6 2 changes the group from the group #2 to the group #1. That is, the end node #6 2 joins the group #1.

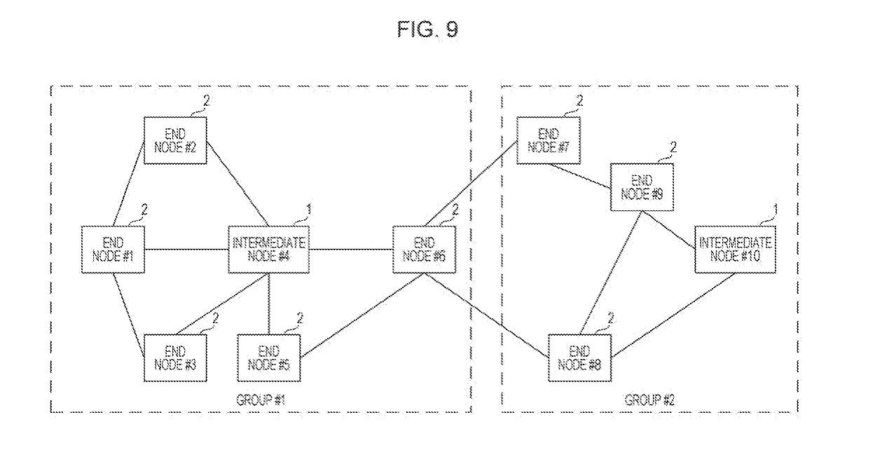

FIG. 9 is a diagram illustrating the network system after the group change. In the group #2, the node #10 operates as the intermediate node 1 instead of the node #7. In addition, the group of the node #6 is changed from the group #2 to the group #1.

As described above, in this example, when there is no end node 2 that satisfies the delay condition from among the end nodes 2 that belong to the group #2, the end node #10 2 that satisfies the load condition removes the end node #6 2 that belongs to the group #2 from the group so that the delay condition is satisfied. Therefore, even when there is no end node 2 that satisfies the delay condition, replacement of the intermediate node 1 may be performed. There may be a plurality of end nodes 2 removed from the group, differently from this example.

In addition, the end node #6 2 that has been removed from the group #2 joins the other group #1 in which the end node #6 2 satisfies the delay condition. Therefore, the end node #6 2 may receive supply of tokens from the intermediate node #4 1 in the group #1 that the node #6 2 has joined and continue the bandwidth control.

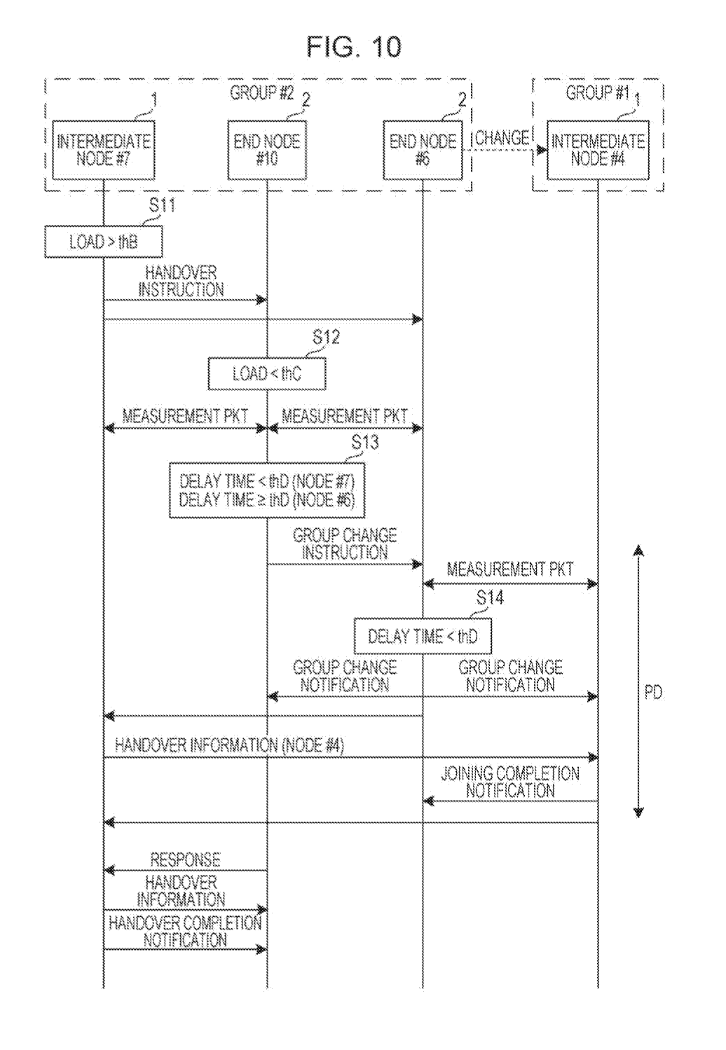

FIG. 10 is a sequence diagram illustrating an example of the above-described group change. In FIG. 10, from among the time periods PA to PC, the time period PB of the replacement of the intermediate node 1 is merely illustrated, and a symbol PD indicates a time period of group change in the time period PB of the replacement of the intermediate node 1.

When the intermediate node #7 1 of the group #2 detects that the load of the processing of the device exceeds the certain value thB (see symbol S11 in FIG. 10), the intermediate node #7 1 transmits a handover instruction to the end nodes #6 and #10 2. The end node #10 2 satisfies the load condition because the load of the processing is smaller than a certain value thC (see symbol S12 in FIG. 10). Therefore, the end node #10 2 transmits a measurement packet to the intermediate node #7 1 and the end node #6 2, and measures delay times of communication with the intermediate node #7 1 and the end node #6 2.

As a result of the delay measurement, the end node #10 2 determines that the delay time of communication with the intermediate node #7 1 is smaller than the threshold value thD, but the delay time of communication with the end node #6 2 is the threshold value thD or more (see symbol S13 in FIG. 10). It is assumed that delay times of communication with the other end nodes #8 and #9 2 are smaller than the threshold value thD.

In the time period PD of the group change, the end node #10 2 transmits a group change instruction to the end node #6 2 in which the delay time is the threshold value thD or more. When the end node #6 2 receives the group change instruction, the end node #6 2 transmits a measurement packet to the intermediate node #4 1 and the end nodes that are not illustrated #1 to #3, and #5 2 in the adjacent group #1. As a result, whether the end node #6 2 satisfies the delay condition in the group #1 is determined.

As a result of the delay measurement, the end node #6 2 determines that the delay times for all of the nodes #1 to #5 of the group #1 are smaller than the threshold value thD (see symbol S14 in FIG. 10). Next, in order to notify that the group of the end node #6 2 is allowed to change to the group #1, so that the end node #6 2 transmits group change notification to the intermediate node #4 1 of the group #1, and the intermediate node #7 1 and the end node #10 2 of the group #2.

The intermediate node #7 1 of the group #2 transmits handover information including the token accumulation amount of the node #6 to the intermediate node #4 1 of the group #1 that is a group change destination. Therefore, the end node #6 2 may continue the bandwidth control in the state in which the previous token accumulation amount and the like have been handed over.

When the intermediate node #4 1 of the group #1 receives the handover information, the intermediate node #4 1 reflects the handover information on the relay memory 17 and the like of the device, and updates the group management table 19 along with the group change of the node #6. The intermediate node #4 1 transmits joining completion notification of the node #6 to the end node #6 2 and the intermediate node #7 1 of the group #2.

Next, the end node #10 2 transmits a response for a handover instruction to the intermediate node #7 1. The intermediate node #7 1 transmits the handover information to the end node #10 2, and then, transmits handover completion notification to the end node #10 2. The group change is performed as described above.

Due to such group change, the number of nodes each of which is to be a candidate of the intermediate node 1 such as the node #6 may increase. For example, as described with reference to FIG. 4, when the intermediate node 1 is selected for each of the pieces of traffic of the users, the increase in the number of candidates of the intermediate node 1 directly results in an increase in the number of pieces of traffic of the users, which are allowed to be accommodated in the nodes.

For example, in the examples of FIGS. 8 and 9, it is assumed that the nodes #7 to #9 of the group #2 each accommodates pieces of traffic of the three users as the intermediate node 1, and the load of the processing of each of the nodes #7 to #9 reaches 80(%) that is an upper limit value. At that time, when the node #10 is added to the group #2 as an intermediate node 1, pieces of traffic of three users are allowed to be newly accommodated in the node, so that the accommodation rate of the pieces of traffic is improved by 33(%).

In the above-described example, the group change of the node #6 is performed, but the embodiment is not limited to the example. For example, when there is no another group in which the node #6 does not satisfy the delay condition, the node #6 may configure a new group independently. However, when the number of groups increases, the load of the network management device 8 also increases, so that it is desirable that the upper limit of the number of groups is set.

The operations of the network management device 8, the intermediate node 1, and the end node 2 are described below using a flowchart.

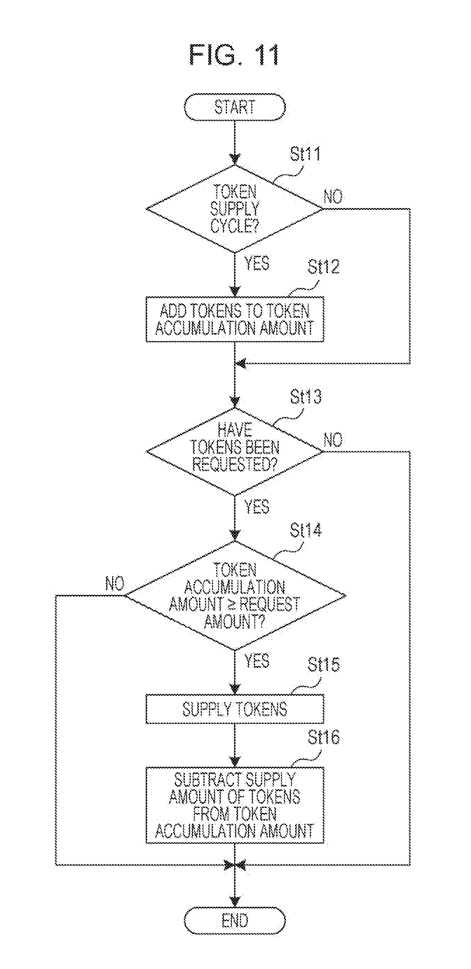

FIG. 11 is a flowchart illustrating an operation example of the network management device 8. The operation is performed, for example, periodically.

The management unit 80 of the network management device 8 determines whether a supply cycle of tokens has arrived (Operation St11). When the management unit 80 has determined that the supply cycle of tokens has arrived (Yes in Operation St11), the management unit 80 adds tokens to the token accumulation amount of the main bucket 70 by a certain amount (Operation St12). In addition, when the management unit 80 has determined that the supply cycle of tokens does not arrive (No in Operation St11), the management unit 80 does not execute the processing of Operation St12. The main bucket 70 is constituted by a memory or the like. In addition, the supply cycle of tokens is detected, for example, by a timer.

Next, the management unit 80 determines the presence or absence of a request of tokens (request packet) from the intermediate node 1 (Operation St13). When the management unit 80 has determined that there is no request of tokens (No in Operation St13), the management unit 80 ends the operation. In addition, when the management unit 80 has received a request of tokens (Yes in Operation St13), the management unit 80 compares the request amount to the token accumulation amount (Operation St14). The request amount is, for example, 1 Mbyte.

When “token accumulation amount<request amount” is satisfied (No in Operation St14), the management unit 80 ends the operation. In addition, when “token accumulation amount≧request amount” is satisfied, (Yes in Operation St14), the management unit 80 supplies tokens to the intermediate node 1 in response to the request so as to transmit a supply packet to the intermediate node 1 (Operation St15).

Next, the management unit 80 subtracts the supply amount of the tokens from the token accumulation amount (for example, 1 Mbyte) (Operation St16) and ends the operation. The network management device 8 operates as described above.

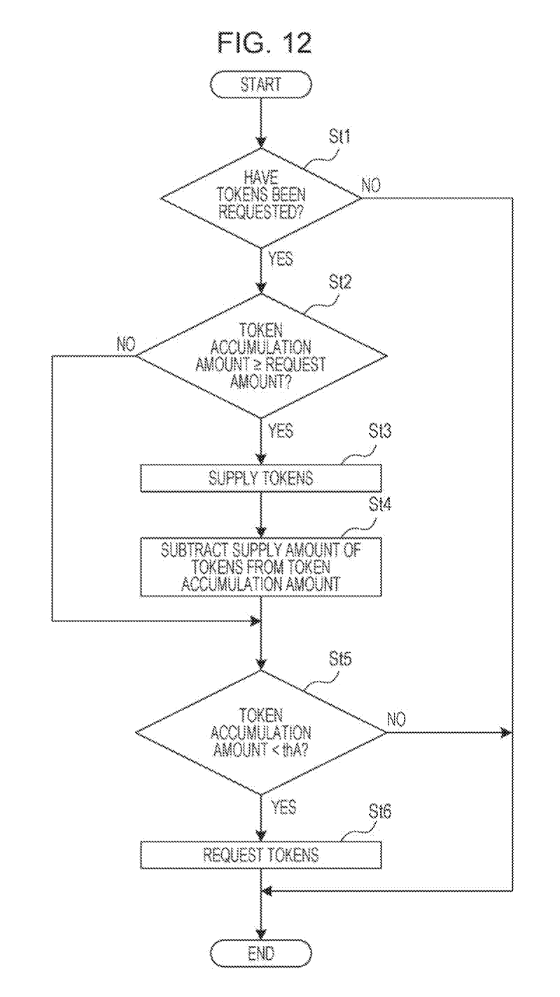

FIG. 12 is a flowchart illustrating an operation example of request and supply of tokens in the intermediate node 1. The operation is performed, for example, periodically.

The relay processing unit 13 of the intermediate node 1 determines the presence or absence of a request of tokens (request packet) from the end node 2 (Operation St1). When the relay processing unit 13 has determined that there is no request of tokens (No in Operation St1), the relay processing unit 13 ends the operation. In addition, when the relay processing unit 13 has received a request of tokens (Yes in Operation St1), the relay processing unit 13 compares the request amount to the token accumulation amount of the relay memory 17, that is, the intermediate bucket 71 (Operation St2). The request amount is, for example, 25 Kbyte.

When “token accumulation amount≧request amount” is satisfied (Yes in Operation St2), the relay processing unit 13 supplies tokens to the end node 2 in response to the request so as to transmit a supply packet to the end node 2 (Operation St3). Next, the management unit 80 subtracts a supply amount of tokens (for example, 25 Kbyte) from the token accumulation amount (Operation St4). In addition, when “token accumulation amount<request amount” is satisfied (No in Operation St2), the relay processing unit 13 does not execute the processing of Operations St3 and St4.

Next, the relay processing unit 13 compares the token accumulation amount to a certain value thA (Operation St5). When “token accumulation amount<thA” is satisfied (Yes in Operation St5), the relay processing unit 13 requests tokens to the network management device 8 so as to transmit a request packet (Operation St6) and ends the operation. In addition, when “token accumulation amount≧thA” is satisfied (No in Operation St5), the relay processing unit 13 ends the operation without execution of the processing of Operation St6. The request and supply of tokens are performed in the intermediate node 1 as described above.

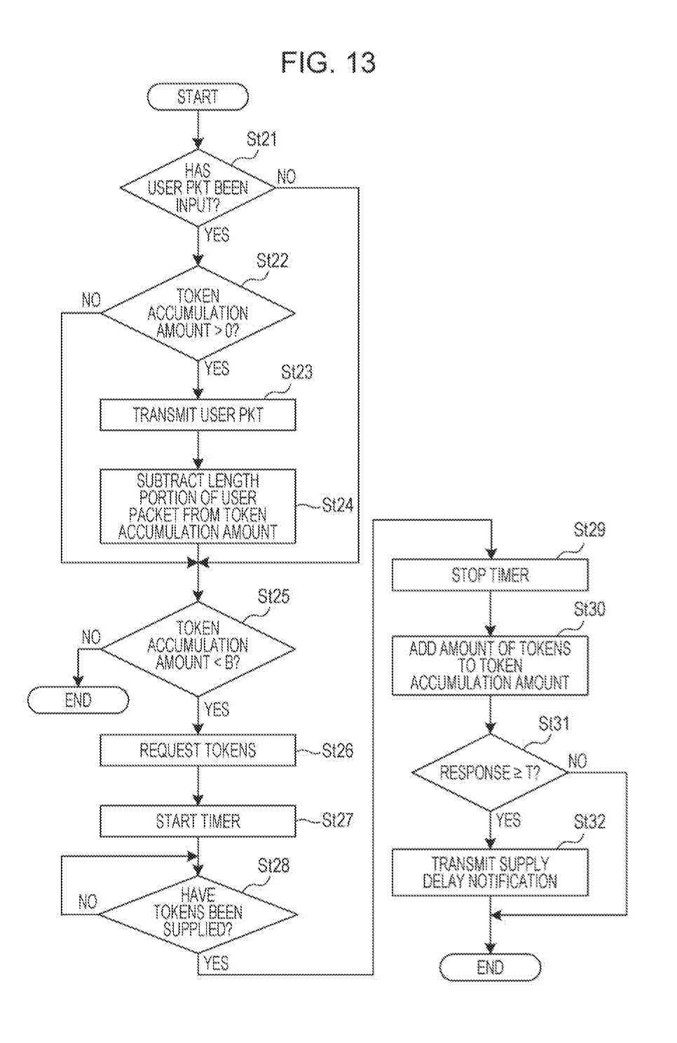

FIG. 13 is a flowchart illustrating an operation example of user packet transmission in the end node 2. The operation is performed, for example, periodically.

The transmission control unit 11 determines the presence or absence of input of a user packet (Operation St21). When the transmission control unit 11 has determined the presence of input of a user packet (Yes in Operation St21), the token management unit 14 determines whether the token accumulation amount of each of the mini-buckets 72 and 74, that is, the management memory 18 is more than 0 (Operation St22).

When “token accumulation amount>0” is satisfied (Yes in Operation St22), the transmission control unit 11 performs transmission of a user packet (Operation St23). Next, the token management unit 14 subtracts a length portion of the user packet from the token accumulation amount (Operation St24).

As described above, when the token accumulation amount is more than 0, the transmission control unit 11 consumes tokens having the length portion of the user packet and performs transmission of a user packet. Therefore, the transmission rate of user packets is controlled based on the token accumulation amount. When the token accumulation amount is the length portion of the user packet or more, the transmission control unit 11 may perform transmission of the user packet.

In addition, the transmission control unit 11 has determined the absence of an input of a user packet (No in Operation St21), the transmission control unit 11 does not execute the processing of Operations St22 to St24, and when “token accumulation amount≦0” is satisfied (No in Operation St22), the transmission control unit 11 does not execute the processing of Operations St23 and St24.

Next, the token management unit 14 compares the token accumulation amount of the management memory 18 to a certain threshold value B (Operation St25). When “token accumulation amount≧B” is satisfied (No in Operation St25), the token management unit 14 ends the operation. In addition, when “token accumulation amount<B” is satisfied (Yes in Operation St25), the token management unit 14 requests tokens for the intermediate node 1 so as to transmit a request packet to the intermediate node 1 through the relay processing unit 13 (Operation St26). At that time, the token management unit 14 obtains an IP address of the intermediate node 1 from the group management table 19 as a transmission destination.

Next, the token management unit 14 starts a timer in order to measure a response time of the intermediate node 1 for the request (Operation St27). Next, the token management unit 14 determines the presence or absence of supply of tokens in response to the request (Operation St28). When the token management unit 14 has determined that there is no supply of tokens (No in Operation St28), the token management unit 14 executes the determination processing of Operation St28 again. In addition, the token management unit 14 has determined that there is supply of tokens (Yes in Operation St28), the token management unit 14 stops the timer (Operation St29). Therefore, a response time of the intermediate node 1 is measured.

Next, the token management unit 14 adds an amount of tokens that have been supplied by a supply packet to the token accumulation amount (Operation St30). Next, the token management unit 14 compares the measured response time to a certain time T (Operation St31). When “response time≧T” is satisfied (Yes in Operation St31), the token management unit 14 transmits supply delay notification to the intermediate node 1 through the relay processing unit 13 (Operation St32) and ends the operation. Therefore, the intermediate node 1 may detect timing of handover easily.

In addition, when “response time<T” is satisfied (No in Operation St31), the token management unit 14 ends the operation. The user packet transmission in the end node 2 is performed as described above.

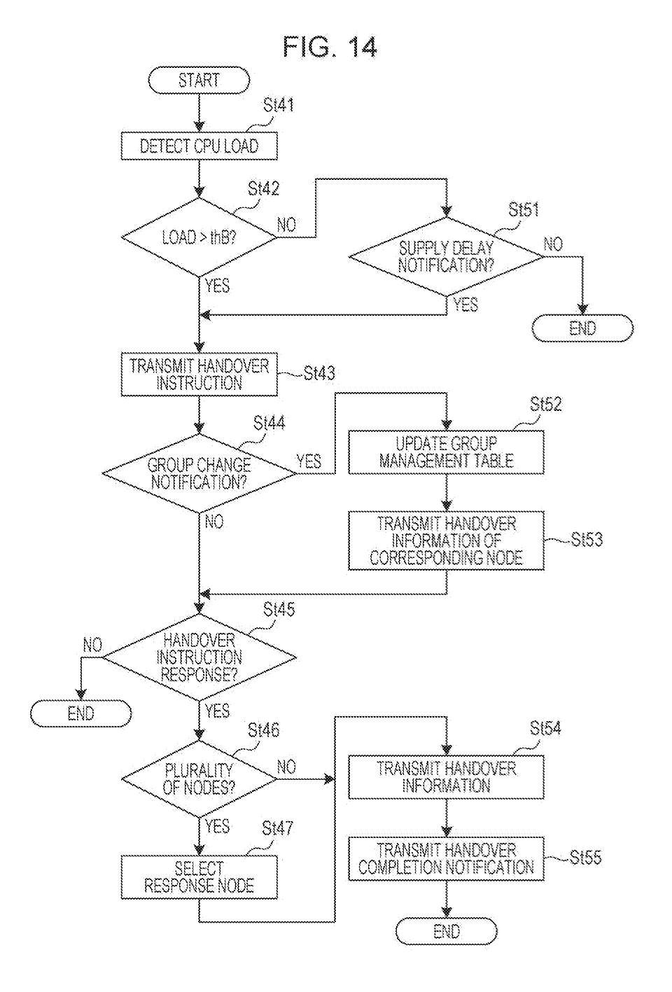

FIG. 14 is a flowchart illustrating an example of a handover operation of request processing and supply processing of tokens in the intermediate node 1. The operation is performed, for example, periodically.

The handover control unit 15 detects the load of the CPU 100 (Operation St41), and compares the load with to certain value thB (Operation St42). When “load>thB” is satisfied (Yes in Operation St42), the handover control unit 15 transmits a handover instruction to each of the nodes 2 in the same group (Operation St43). At that time, the handover control unit 15 obtains a transmission destination of the handover instruction from the group management table 19.

In addition, when “load≦thB” is satisfied (No in Operation St42), the handover control unit 15 determines the presence or absence of supply delay notification from the end node 2 (Operation St51). When the handover control unit 15 has determined that there is no supply delay notification (No in Operation St51), the handover control unit 15 ends the operation. In addition, when the handover control unit 15 has received supply delay notification (Yes in Operation St51), the handover control unit 15 executes the processing of Operation St43. The handover control unit 15 may execute merely determination processing of one of Operations St42 and St51.

Next, the handover control unit 15 determines the presence or absence of group change notification (Operation St44). When the handover control unit 15 has received group change notification (Yes in Operation St44), the handover control unit 15 updates the group management table 19 (Operation St52). In the examples of FIGS. 8 to 10, the handover control unit 15 changes the ID of the group to which the node #6 belongs from #2 to #1.

Next, the handover control unit 15 transmits handover information of a corresponding node to the intermediate node 1 of a group that is a change destination (Operation St53). In the examples of FIGS. 8 to 10, the handover control unit 15 transmits handover information of the node #6 to the intermediate node #4 1 of the group #1. In addition, when the handover control unit 15 does not receive group change notification (No in Operation St44), the handover control unit 15 does not execute the processing of Operations St52 and St53.

Next, the handover control unit 15 determines the presence or absence of a response for the handover instruction from the end node 2 (Operation St45). When the handover control unit 15 has determined that there is no response (No in Operation St45), the handover control unit 15 ends the operation. In addition, the handover control unit 15 has received the response (Yes in Operation St45), the handover control unit 15 determines whether responses have been received from a plurality of end nodes 2 (Operation St46).

When responses have been received from a plurality of end nodes 2 (Yes in Operation St46), the handover control unit 15 selects an end node 2 that is a handover target from the end nodes 2 that are the response sources (Operation St47). At that time, the handover control unit 15 selects an end node 2 from which a response has been received at the earliest timing, as an example. In addition, when the handover control unit 15 has received a response merely from a single end node 2 (No in Operation St46), the handover control unit 15 does not execute the processing of Operation St47.

Next, the handover control unit 15 transmits the handover information to the end node 2 that is a handover target (Operation St54). Next, the handover control unit 15 transmits handover completion notification to each of the end nodes 2 in the same group (Operation St55). The handover operation of the request processing and the supply processing of tokens in the intermediate node 1 is performed as described above.

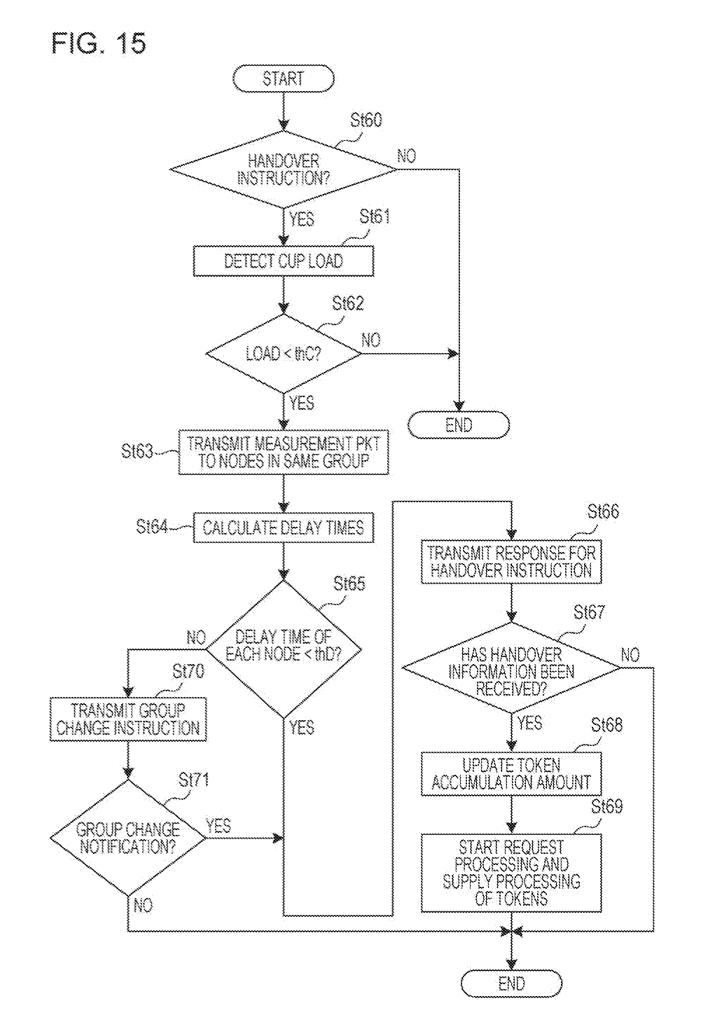

FIG. 15 is a flowchart illustrating an operation example when a handover instruction has been received at the end node 2. The operation is performed, for example, periodically.

The handover control unit 15 determines the presence or absence of a handover instruction from the intermediate node 1 (Operation St60). When the handover control unit 15 has determined that there is no handover instruction (No in Operation St60), the handover control unit 15 ends the operation. In addition, when the handover control unit 15 has received a handover instruction (Yes in Operation St60), the handover control unit 15 detects the load of the CPU 100 (Operation St61).

Next, the handover control unit 15 compares the detected load to the certain value thC (Operation St62). That is, the handover control unit 15 determines whether the device satisfies the load condition. When “load≧thC” is satisfied (No in Operation St62), the handover control unit 15 determines that the load condition is not satisfied, and ends the operation.

In addition, when “load<thC” is satisfied (Yes in Operation St62), that is, when the load condition is satisfied, the delay measurement unit 16 transmits a measurement packet to the intermediate node 1 and the end nodes 2 in the same group (Operation St63), and calculates a delay time of communication for each of the end nodes 2 (Operation St64). At that time, the delay measurement unit 16 obtains a transmission destination of the measurement packet from the group management table 19. The calculated delay time is notified to the handover control unit 15.

Next, the handover control unit 15 compares the delay time to the threshold value thD, for each of the nodes (Operation St65). That is, the handover control unit 15 determines whether the device satisfies the delay condition.

When “delay time<thD” is satisfied, that is, the delay condition is satisfied for all of the nodes (Yes in Operation St65), the handover control unit 15 transmits a response for the handover instruction to the intermediate node 1 (Operation St66). Next, the handover control unit 15 determines whether handover information has been received from the intermediate node 1 (Operation St67). When the handover control unit 15 does not receive handover information (No in Operation St67), the handover control unit 15 ends the operation.

In addition, when the handover control unit 15 has received handover information (Yes in Operation St67), the handover control unit 15 updates a token accumulation amount of the relay memory 17 based on the handover information (Operation St68). Next, the handover control unit 15 instructs the relay processing unit 13 to start the request processing and the supply processing of tokens (Operation St69), and ends the operation. Therefore, the relay processing unit 13 starts the operation as the intermediate node 1.

In addition, when “delay time≧thD” is satisfied, that is, the delay condition is not satisfied, for at least one of the nodes (No in Operation St65) the handover control unit 15 transmits a group change instruction to the node that satisfies “delay time≧thD” (Operation St70). In the examples of FIGS. 8 to 10, the handover control unit 15 transmits the group change instruction to the node #6. As described above, when there is no node that satisfies the delay condition from among other the nodes that belong to the same group, the handover control unit 15 removes at least one of the nodes that belong to the same group from the group so that the delay condition is satisfied.

Next, the handover control unit 15 determines whether group change notification has been received from the node that is a transmission destination of the group change instruction (Operation St71). When the handover control unit 15 does not receive group change notification (No in Operation St71), the handover control unit 15 ends the operation. In addition, when the handover control unit 15 has received group change notification (Yes in Operation St71), the handover control unit 15 executes the processing of Operations St66 to St69 and ends the operation. The operation at the time of reception of a handover instruction in the end node 2 is performed as described above.

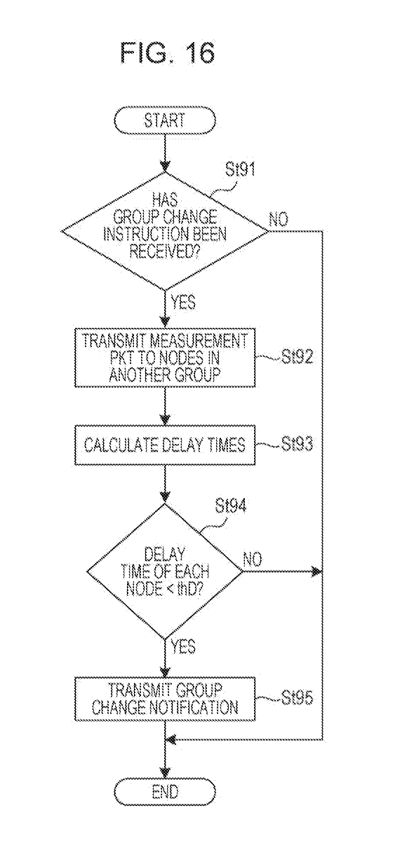

FIG. 16 is a flowchart illustrating an operation example when a group change instruction has been received at the end node 2. The operation is performed, for example, periodically. The operation is performed at the node #6 in the examples of FIGS. 8 to 10.

The handover control unit 15 determines the presence or absence of a group change instruction from another end node 2 (Operation St91). When the handover control unit 15 has determined that there is no group change instruction (No in Operation St91), the handover control unit 15 ends the operation. When the handover control unit 15 has received a group change instruction (Yes in Operation St91), the delay measurement unit 16 transmits a measurement packet to each node in another group (Operation St92), and calculates a delay time (Operation St93). At that time, the delay measurement unit 16 obtains a transmission destination of the measurement packet from the group management table 19. The calculated delay time is notified to the handover control unit 15.

Next, the handover control unit 15 compares the delay time of each of the nodes to the threshold value thD (Operation St94). That is, the handover control unit 15 determines whether the delay condition is satisfied in the other group.

When “delay time<thD” is satisfied, that is, the delay condition is satisfied for all of the nodes (Yes in Operation St94), the handover control unit 15 transmits group change notification to the end node 2 that is a reception source of the group change instruction (Operation St95), and ends the operation. Therefore, the end node notifies the transmission source of information indicating that group change of the end node 2 is allowed to be performed.

In addition, when “delay time≧thD” is satisfied, that is, the delay condition is not satisfied for at least one of the nodes (No in Operation St94), the handover control unit 15 ends the operation. As described above, the operation at the time of reception of group change instruction in the end node 2 is performed.

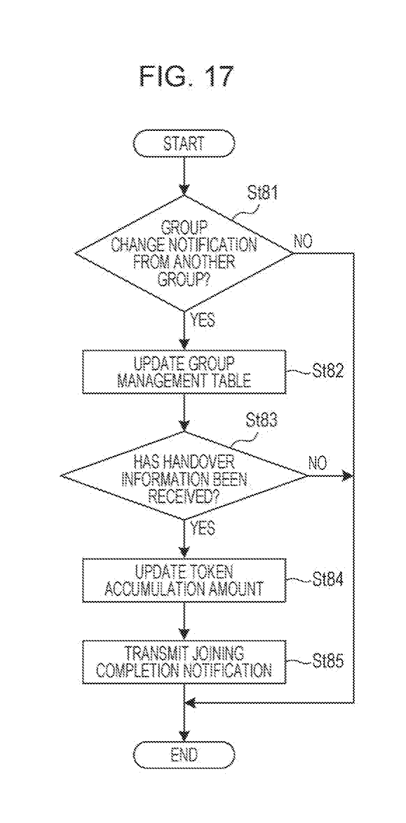

FIG. 17 is a flowchart illustrating an operation example in the intermediate node 1 at the time of group joining of the end node in the other group. The operation is performed, for example, periodically. The operation is performed in the node #4 of the group #1 in the examples of FIGS. 8 to 10.

The handover control unit 15 determines the presence or absence of group change notification from the node of the other group (Operation St81). At that time, the handover control unit 15 determines that the transmission source of the group change notification corresponds to the other group with reference to the group management table 19 based on the transmission source of the group change notification.

When the handover control unit 15 does not receive group change notification (No in Operation St81), the handover control unit 15 ends the operation. In addition, when the handover control unit 15 has received group change notification (Yes in Operation St81), the handover control unit 15 updates the group management table 19 (Operation St82). In the examples of FIGS. 8 to 10, the handover control unit 15 changes the group ID of the node #6 from #2 to #1. As described above, the node #6 that has removed from the group joins the other group #1 that satisfies the delay condition.

Next, the handover control unit 15 determines whether handover information has been received from the intermediate node 1 of the group that corresponds to the transmission source of the group change notification (Operation St83). When the handover control unit 15 does not receive handover information (No in Operation St83), the handover control unit 15 ends the operation.

In addition, when the handover control unit 15 has received handover information (Yes in Operation St83), the handover control unit 15 updates the token accumulation amount of the relay memory 17 based on the handover information (Operation St84). Next, the handover control unit 15 transmits joining completion notification of the corresponding node to the intermediate node 1 and the corresponding node in the group that corresponds to the transmission source of the group change notification (Operation St85). At that time, the handover control unit 15 obtains the transmission destination of the joining completion notification from the group management table 19. The operation in the intermediate node 1 at the time of group joining of the end node in the other group is performed as described above.

As the intermediate node 1, for example, there is a relay switch such as a router that relays a packet. Thus, the bandwidth control in which there is no delay over the whole network is achieved by applying the above-described control method of traffic to a policer or a shaper that has been installed in the relay switch.

In addition, the intermediate node 1 relays tokens to the end node 2, so that the intermediate node 1 is not limited to a relay switch, and for example, may be a server in a network or a cloud. In this case, the CPU 100 that executes relay processing of tokens may be a CPU that is specific to the relay processing, or may be a CPU that doubles as a processor that executes processing in which firewall or the like is different. Such a configuration is employed, for example, when the whole processing performance of the relay switch in the network is low, or when the function of the intermediate node 1 is achieved by software on a server as a single application of network functions virtualization (NFV).

As described above, the intermediate node 1 according to the embodiment that is an example of a communication device belongs to a group of the plurality of nodes 1 and 2 each of which controls the transmission rate of packets based on a supplied token, and includes the relay processing unit 13 and the handover control unit 15. The relay processing unit 13 requests tokens to the network management device 8 that manages the plurality of nodes, and supplies tokens that have been supplied in response to the request, to another end node 2 in the group, in response to a request.

The handover control unit 15 hands over the request processing and the supply processing of tokens, which are executed by the relay processing unit 13, to an end node 2 that satisfies the delay condition related to a delay time of communication in the group and the load condition related to the load of the processing from among the end nodes 2 that belong to the group.

In the above-described configuration, the relay processing unit 13 supplies tokens that has been supplied from the network management device 8, to the end node 2 in the group in response to a request. Therefore, the number of requests of tokens for the network management device 8 is reduced as compared with the comparative example, and an increase in the load of the processing is suppressed. In addition, the handover control unit 15 hands over the request processing and the supply processing of tokens to an end node 2 of the group that satisfies the delay condition and load the condition. As a result, from among the end nodes 2 in the group, an end node 2 in which the delay is low and the load is low is selected as a new intermediate node 1, so that the request processing and the supply processing of tokens are continued appropriately even after the handover.

Thus, in the intermediate node 1 according to the embodiment, a delay time of the bandwidth control of traffic that flows through the network is reduced.

In addition, the network management device 8 according to the embodiment includes the management unit 80. The management unit 80 manages the plurality of nodes 1 and 2 that are provided for each group and each of which controls the transmission rate of packets based on a supplied token. In addition, the management unit 80 supplies tokens to the intermediate node 1 that has been selected for each of the groups from among the plurality of nodes in response to a request from the intermediate node 1.

The intermediate node 1 requests tokens for the network management device 8 and supplies the tokens that have been supplied in response to the request to, an end node 2 in the group, in response to a request. In addition, the intermediate node 1 hands over the request processing and the supply processing of tokens, which are executed by the relay processing unit 13, to an end node 2 that satisfies the delay condition related to a delay time of communication in the group and the load condition related to the load of the processing among the end nodes 2 that belong to the group.

The network management device 8 according to the embodiment achieves an operation effect similar to that of the above-described content because the network management device 8 includes a configuration that is similar to that of the above-described intermediate node 1.

In addition, the network system according to the embodiment includes the plurality of nodes 1 and 2 and the network management device 8. The plurality of nodes 1 and 2 are provided for each group and each controls the transmission rate of packets based on a supplied token. The network management device 8 manages the plurality of nodes 1 and 2.

From among the plurality of nodes 1 and 2, the intermediate node 1 that has been selected for each of the groups requests tokens for the network management device 8, and supplies tokens that have been supplied in response to the request, to an end node 2 that belongs to the group, in response to a request. In addition, the intermediate node 1 hands over the request processing and the supply processing of tokens, which are executed by the relay processing unit 13, to an end node 2 that satisfies the delay condition related to the delay time of communication in the group and the load condition related to the load of the processing among the end nodes 2 that belong to the group.

The network system according to the embodiment achieves an operation effect similar to that of the above-described content because the network system includes a configuration that is similar to that of the above-described intermediate node 1.

The above-described embodiments are desired examples of the technology discussed herein. However, the embodiments are not limited to the examples, and various modifications may be implemented within the scope not departing from the gist of the technology discussed herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device in a network formed by a plurality of communication devices and a network management device, the communication device of the plurality of communication devices comprising:
a memory configured to store a procedure for controlling a transmission rate of a packet based on an amount of tokens;
a processor configured to execute the procedure by:
requesting the amount of tokens to the network management device; and
supplying the amount of tokens supplied from the network management device in response to the requesting, to other communication devices belonging to a group to which the communication device also belongs; and
a hardware processor configured to transfer request processing and supply processing of the amount of tokens which are executed by the processor, to one of the other communication devices belonging to the group, that satisfies a delay condition related to a delay time of communication and a load condition related to a load of processing in the group.

2. The communication device according to claim 1,
wherein the hardware processor monitors a load level of processing of the communication device, and when the load level exceeds a predetermined value, transfers the request processing and supply processing of the amount of tokens which are executed by the processor, to one of the other communication devices belonging to the group, that satisfies the delay condition and the load condition.

3. The communication device according to claim 1,
wherein the hardware processor, when it is notified from the other communication devices that a response time of the processor for the requesting of the amount of tokens is a predetermined time or more, transfers the request processing and supply processing of the amount of tokens, which are executed by the processor, to one of the other communication devices belonging to the group, that satisfies the delay condition and the load condition.

4. A network management device in a network including a plurality of communication devices, the network management device comprising:
a hardware processor configured to:
manage the plurality of communication devices each belonging to any one of groups, a communication device of the plurality of communication devices controlling a transmission rate of a packet based on an amount of tokens, and
supply, in response to a request of the amount of tokens from the communication device, the amount of tokens to the communication device,
wherein the communication device, in response to the request, supplies the amount of tokens supplied from the network management device to other communication devices belonging to the group, and transfers request processing and supply processing of the amount of tokens to one of the other communication devices belonging the group, that satisfies a delay condition related to a delay time of communication and a load condition related to a load of processing.

5. A network system comprising:
a plurality of communication devices each configured to control a transmission rate of a packet based on an amount of tokens; and
a network management device configured to manage the plurality of communication devices,
wherein each of the plurality of communication devices belongs to any one of groups, and
wherein a first communication device of the plurality of communication devices in a group of the groups:
requests the amount of tokens to the network management device,
supplies the amount of tokens supplied from the network management device in response to requesting the amount of tokens to the network management device, to other communication devices belonging to the group, and
transfers request processing and supply processing of the amount of tokens to a second communication device of the other communication devices, that satisfies a delay condition related to a delay time of communication and a load condition related to a load of processing in the group.

6. The network system according to claim 5,
wherein at least one of the communication devices belonging to the group is excluded from the group so that the delay condition of a communication device that satisfies the load condition is satisfied in a case where there is no communication device that satisfies the delay condition in the other communication devices.

7. The network system according to claim 6,
wherein the at least one of the communication devices, which is excluded from the group, is included in another group in which the delay condition is satisfied.

8. The network system according to claim 5,
wherein a load level of processing of the first communication device is lowest in the group.

9. The network system according to claim 5,
wherein a maximum delay time of communication of the first communication device is smallest in the group.

10. The network system according to claim 5,
wherein the first communication device is located closest to the network management device in the group.

11. The network system according to claim 5,
wherein the first communication device monitors a load level of processing of the first communication device, and when the load level exceeds a predetermined value, transfers the request processing and supply processing of the amount of tokens, to the second communication device.

12. The network system according to claim 5,
wherein the first communication device, when it is notified from the other communication devices that a response time for the request of the amount of tokens is a predetermined time or more, transfers the request processing and supply processing of the amount of tokens, to the second communication device.
